(19) United States
(12) Patent Application Publication
(10) Pub. No.: US 2011/0018253 A1
(43) Pub. Date: Jan. 27, 2011

(54) SECURITY ELEMENT

(75) Inventors: Thomas Birsztejn, Dormagen (DE); Markus Gerigk, Koln (DE); Ludger Brüll, Leverkusen (DE); Andreas Bäcker, Wuppertal (DE); Simon Vougioukas, Koln (DE); Ralf Imhäuser, Langenfeld (DE); Nils Winkler, Neuss (DE); Rainer Mackowiak, Neuss (DE)

Correspondence Address: Hildebrand, Christa;Norris McLaughlin & Marcus PA, 875 Third Avenue, 8th Floor, New York, NY, 10022, US

(73) Assignee: BAYER TECHNOLOGY SERVICES GMBH, Leverkusen (DE)

(21) Appl. No.: 12/865,578

(22) PCT Filed: Jan. 24, 2009
(86) PCT No.: PCT/EP2009/000451

§ 371 Date: Oct. 1, 2010

(30) Foreign Application Priority Data
Feb. 5, 2008 (DE) 10 2008 007 731.3
Apr. 2, 2008 (DE) 10 2008 016 803.3
Oct. 29, 2008 (DE) 10 2008 053 798.5

(51) Int. Cl. B42D 15/00

(52) U.S. Cl. 283/81; 283/85

(57) ABSTRACT

A security element for the identification and authentication of objects is disclosed. The element is connected by a self-adhesive label to an object. It has features that effectively prevent non-destructive detachment of the security element from an object. The security element has an optical code for identification. Furthermore, it is provided with random production-governed features by means of which authentication is made possible: upon irradiation with electromagnetic radiation, a scattering region of the security element brings about a characteristic scattering signal. The method of using the security element is disclosed for the identification and authentication of objects and also for protection against forgeries, and a method for the identification and authentication of objects on the basis of the security element.

The invention relates to a security element, the use of the security element for the identification and authentication of objects and also for protection against forgeries, and a method for the identification and authentication of objects on the basis of the security element according to the invention.

The automated recognition of objects by means of optical methods is known according to the prior art. Everyone is familiar with bar codes, for example, which are applied to goods and/or packagings and which permit machine identification of the goods in order to determine e.g. the price.

One known representative of the bar codes is the EAN 8 code defined in the international standard ISO/IEC 15420. It codes a sequence of 8 numerals in the form of bars and gaps of different widths. In general, the bars are printed with a black printing ink onto a white carrier, e.g. the packaging of the object to be identified, or onto the object itself.

In addition to the EAN 8 code described there are numerous further bar codes which code not only numerals but also letters, special characters and control characters. Furthermore, some codes contain error detection and error correction characters that allow errors in signal transmission to be detected and in part even corrected. A further development of bar codes is 2D codes, in which the information is optically coded not just one-dimensionally but in two dimensions. The so-called matrix codes form a subgroup of the 2D codes. One known representative is e.g. the data matrix code defined in the international standard ISO/IEC 16022.

Machine-readable optical codes such as the abovementioned bar codes, 2D codes and matrix codes but also OCR-Text (OCR=Optical Character Recognition) or similar optically machine-readable codes shall be subsumed hereinafter under the umbrella term optical codes.

Optical codes can be created simply and extremely cost-effectively (printing) and are fast and robust in detection. They are ideally suited to the identification of objects. In particular, optical codes are suitable for object tracking (track & trace). In this case, an object is assigned a unique number, for example, such that the object can be identified at every station in the logistics chain and it is thereby possible to track the movement of the object from one station of the logistics chain to another.

However, optical codes do not afford protection against forgery, since they can be copied and reproduced in a simple manner.

For security against forgery, identity cards, banknotes, products, etc. are nowadays provided with elements which can be imitated only with special knowledge and/or high technical complexity. Such elements are referred to here as security elements. Security elements are preferably inseparably connected to the objects to be protected. The attempt to separate the security elements from the object preferably leads to their destruction, in order that the security elements cannot be misused.

The authenticity of an object can be checked on the basis of the presence of one or more security elements. The method for checking the authenticity of an object is referred to here as authentication.

Optical security elements such as e.g. watermarks, special inks, guilloche patterns, microscripts and holograms are established worldwide. An overview of optical security elements, which in particular however are not exclusively suitable for document protection, is given by the following book: Rudolf L. van Renesse, Optical Document Security, Third Edition, Artech House Boston/London, 2005 (pp.63-259).

WO2005088533(A1) describes a method by which objects can be identified and authenticated on the basis of their characteristic surface structure. In this case, the method manages without additional means such as security elements, for example, which are connected to the objects. In the method, a laser beam is focused onto the surface of the object, and moved over the surface (scanning), and the beams scattered to different extents at different angles at different locations of the surface are detected by means of photodetectors. The scattering radiation detected is characteristic of a multiplicity of different materials and can be imitated only with very great difficulty, since it is attributable to random occurrences during the production of the object. By way of example, paper-like objects have a production-governed fibre structure that is unique for each object produced. The scattering data with respect to the individual objects are stored in a database in order to be able to authenticate the object at a later point in time. For this purpose, the object is measured again and the scattering data are compared with the stored reference data.

The random features of the object that are used in the method in WO2005088533(A1) bring about very high protection against forgery. What is disadvantageous about the method, however, is that it is necessary to create an extensive database for the scattering data of all objects detected. On the one hand, the database has to have a high storage capacity in order to be able to store the high data volumes of scattering data of a large number of objects. On the other hand, the access time to the data in the database has to be fast since the scattering data detected have to be compared with all reference data in the database for an authentication (1:n-match), in order to find the correct data record. Furthermore, not every object has a surface that is accessible to a method in accordance with WO2005088533(A1).

It can therefore be summarized that the prior art provides various methods and devices for the identification and authentication of objects. However, methods and devices for identification by means of optical codes are not suitable for protection against forgery and not suitable for the authentication of objects, owing to the simple forgeability of the features used for identification. Conversely, although the authentication method from WO2005088533(A1) has a high protection against forgery, it is not suitable for identification and object tracking (track & trace), owing to the high volumes of data and the associated stringent requirements made of the IT back-end system (database, network). Furthermore, the method cannot be employed for all objects.

Therefore, proceeding from the known prior art, the problem addressed is that of combining the advantages of optical codes with the advantages of authentication on the basis of random features. The problem addressed is that of providing a solution for identification and authentication of objects which can be employed for a great diversity of different objects, which is simple to implement, which can be established on existing IT infrastructures, which ensures high protection against forgery and which is moreover still cost-effective.

It has surprisingly been found that this problem can be solved by a security element which is irreversibly connected to an object and which comprises a code region and a scattering region, the code region being used for the identification of the object on the basis of an optical code and the scattering region being used for the authentication of the object on the basis of characteristic scattering radiation on account of randomly given features.

Therefore, the present invention relates to a security element in the form of a self-adhesive label for attaching the security element to an object, comprising means that prevent non-destructive detachment of the security element from the object, characterized in that the security element comprises a code region and a visually marked scattering region, the code region comprising an optical code, and the scattering region having randomly distributed and/or oriented scattering centres which, when the scattering region is irradiated with electromagnetic radiation, bring about a unique scattering signal that is characteristic of the security element.

Identification is understood to be the process which serves for unambiguously recognizing an object. If an object has been unambiguously recognized, it can be unambiguously assigned or it is possible to make an unambiguous assignment to the object recognized. By way of example, an identified item of merchandise (object) can be assigned a price or its destination. The identification is effected on the basis of features which characterize the object and distinguish it from other objects.

Authentication is understood to be the process of checking (verifying) an asserted identity. The authentication of objects, documents or data is the ascertainment that the latter are authentic—that is to say that originals that have not been altered, copied or imitated are involved.

Like identification, authentication is also effected on the basis of features which characterize the object and distinguish it from other objects.

The features for identification and the features for the authentication of an object are provided by the security element according to the invention.

The code region comprises the features necessary for identification. For this purpose, the code region comprises at least one optical code, e.g. a bar code or 2D code or some other optically machine-readable code. The optical code preferably codes an identification number unique to the security element. On the basis of the identification number, it is possible to make a unique assignment between the security element and e.g. an entry in a database, a file which includes a characteristic scattering signal as reference, or some other real or virtual object. The optical code is preferably printed with dark ink on a light background. An inverse representation, wherein the optical code is printed in light ink on a dark background, is likewise conceivable.

The size of the code region is determined by the size of the optical code used. The size of the code region usually lies within the range of between 50 mm² and 1000 mm².

It is conceivable for the security element according to the invention to comprise more than one code region and/or more than one optical code.

The scattering region of the security element according to the invention is characterized in that it generates a characteristic scattering signal upon irradiation with electromagnetic radiation. Scattering is understood to mean that electromagnetic beams that impinge in the form of a bundle on a scattering region are reflected back in different directions. While a parallel beam bundle is reflected upon impinging on a plane mirror and in this case is reflected back as a parallel beam bundle at a defined angle, impinging radiation in the case of the scattering region is reflected back in different directions by a multiplicity of scattering centres.

In this case, the scattering centres of the scattering region of a security element according to the invention are subject to a random distribution and/or orientation. Random distribution and/or orientation is understood to mean that the position of individual scattering centres and/or the orientation of individual scattering centres cannot be set in a foreseeable manner by the production process. The position and/or orientation of individual scattering centres is subject to random fluctuations during the production process. Therefore, the position and/or the orientation of individual scattering centres cannot be reproduced in a simple manner. The high protection afforded by the security feature according to the invention is based on this fact: it can be reconstructed only with very high complexity. Furthermore, the random distribution and/or orientation provides for individualization: each security element is unique (individual) owing to the random distribution and/or orientation or the scattering centres, which is manifested in a unique, characteristic scattering signal upon irradiation with electromagnetic radiation.

The scattering centres of a security element according to the invention preferably have a size of one square micrometre to 0.001 square millimetre. The scattering centres can be formed e.g. by pigments (e.g. titanium dioxide) or fibres (e.g. cellulose) or the like.

The scattering centres of a security element according to the invention are preferably provided by a fibrous material having a production-governed random fibre structure that brings about a characteristic scattering radiation upon irradiation with electromagnetic radiation. Such a fibre structure is present e.g. in paper, cardboard or textiles. A paper is preferably used as fibrous material.

Preferably, electromagnetic radiation having at least one wavelength within the range of 300 nm to 1000 nm is scattered by the scattering region of the security element according to the invention.

In one preferred embodiment of the security element according to the invention, the scattering region is visually indicated. This makes clear to a user the location at which authentication is effected on the basis of the characteristic scattering signal. A user therefore knows which location of the security element according to the invention has to be presented to a device for machine authentication. The visual indication is furthermore constituted such that it can also be used by the device for machine authentication as a position marking for the detection of the scattering region.

The scattering region can be visually indicated e.g. by being framed with a solid line.

The size of the scattering region lies within the range of between 50 mm² and 1000 mm². The code region is preferably embodied in rectangular fashion, in which case the corners can be rounded. It is also conceivable to embody the scattering region in square, round, elliptical, oval, triangular, pentagonal or generally n-gonal fashion.

In one preferred embodiment, code region and scattering region are present such that they are spatially separated from one another. However, it is also conceivable for them to wholly or partly overlap, or for one region to completely encompass the other.

The security element according to the invention is preferably embodied as a self-adhesive label in order to be able to be attached to a multiplicity of different objects. A self-adhesive label is understood to be a flat composite having an adhesive layer that enables a connection between a label and an object by means of adhesive bonding. Here a flat body should be understood to mean a body having one spatial extent (thickness) that is at least a factor of 10, preferably at least a factor of 50, smaller than the two remaining spatial extents (length, width). Composite is understood to mean a body composed of two or more materials connected to one another. The connection between the materials preferably arises by means of lamination and/or adhesive bonding.

The security element according to the invention has a layer structure of at least four layers: an adhesive layer, a fibrous-material-containing layer, a printing layer and a protective layer.

The security element according to the invention is connected to an object by means of the adhesive layer. The adhesive layer is adapted to the material properties of the object in order to bring about a good connection between security element and object.

The fibrous-material-containing layer comprises at least one fibrous material that serves for taking up printing ink (dyes, pigments) and that simultaneously provides randomly distributed and/or oriented scattering centres.

There are introduced in the printing layer colour pigments and/or dyes that form the optical code within the code region and, if appropriate, further printing images, scripts, logos, etc.

The security element according to the invention has a protective layer that faces the outside world and protects the lower layers against harmful environmental influences (moisture, mechanical stress, UV radiation, etc.). The protective layer is transparent to at least part of visible electromagnetic radiation in order to be able to view the printing layer, read out the optical code by machine and irradiate the scattering region with electromagnetic radiation and receive a characteristic scattering signal. Preferably, the protective layer is transparent to electromagnetic radiation having at least one wavelength within the range of 300 nm to 1000 nm.

Transparency is understood to mean that the portion of the electromagnetic radiation having at least one wavelength which penetrates through the layer is greater than the sum of the portions of the electromagnetic radiation having at least one wavelength which are absorbed by the layer or are reflected at the interfaces of the layer. The transmittance of the layer is therefore greater than 50%, where transmittance should be understood to mean the ratio of the intensity of the electromagnetic radiation having at least one wavelength which passes through the layer relative to the intensity of the electromagnetic radiation having the at least one wavelength which impinges on the layer.

The individual layers within the security element according to the invention do not necessarily extend over the entire security element. By way of example, not all regions of the fibrous material are printed. In particular, preferably the scattering region is not printed. The printing layer therefore does not extend over the entire cross section of a security element according to the invention. Furthermore, the layers along the layer sequence are not necessarily sharply separable spatially from one another. By way of example, a certain portion of the printing layer will penetrate into the fibre structure of the fibrous material and form a layer comprising fibrous material and printing layer.

One example of a layer sequence in a security element according to the invention is illustrated in FIG. 2. For the sake of simplicity, all the layers in FIG. 2 extend over the entire security element, even though in reality this will normally not be the case.

The layer sequence shown is: a bottommost adhesive protection layer, an adhesive layer, a fibrous-material-containing layer, a printing layer, a protective layer.

Further layers alongside the layers mentioned are conceivable.

For handling purposes, an adhesive protection layer is usually provided below the adhesive layer. Said adhesive protection layer affords protection against undesired adhesive bonding of the adhesive layer to any articles. The adhesive protection layer is removed before the security element according to the invention is attached to an object. The adhesive protection layer usually also serves as a carrier material for one or more security elements. Label-type security elements are usually held in large number on a carrier. The label-type security elements are usually held on a carrier strip that is rolled up to form a roll. It is also conceivable to mount a multiplicity of security elements on arcuate carriers. From the carriers, the security elements can be applied to objects by machine or manually. Films are usually used as carriers.

Furthermore, it is conceivable for a further adhesive layer to be introduced between the printing layer and the protective layer, said further adhesive layer connecting the protective layer to the fibrous material and the printing layer.

The uniqueness of security elements according to the invention permits the individualization of objects to which they are connected. Therefore, the security element according to the invention preferably has features that prevent a non-destructive detachment from an object. The attempt to remove a security element according to the invention from an object leads to the destruction of the security element, such that it becomes unusable. This prevents the security element, which imparts measureable individuality to an object, from being transferred to a different object and thus being misused.

Features for protection against transfer of a security element according to the invention to a different object are formed by the layers, their combination and by stamped portions.

In one preferred embodiment, the security feature according to the invention has a separation layer. The adhesive layer for adhesive bonding to an object and the separation layer are coordinated with one another in such a way that the forces which hold together the separation layer are weaker than the forces which hold together the security element and an object by means of the adhesive layer. The attempt to remove the security element from the object therefore leads rather to separation of the separation layer than to detachment of the adhesive layer from the object. The separation layer accordingly constitutes a desired breaking location. In one preferred embodiment of the security element according to the invention, the separation layer is formed from a fibrous material that irreversibly tears apart along the layer and in the process forms clear tear traces, which indicate a detachment attempt.

In one preferred embodiment, the security element according to the invention has a layer that experiences an irreversible colour change in the event of a specific temperature limit being exceeded and/or undershot (colour change layer).

It is known that adhesive layers can exert their adhesive force only within a limited temperature range (effective adhesive range). At low temperatures, the adhesive can become brittle and thus fragile; at high temperatures, the adhesive can soften. This makes it possible for a potential forger, by means of a temperature change above or below the range in which the adhesive layer is effective, to perform a detachment of the security element from an object. Therefore, such an attempt in the case of the security element according to the invention leads to an irreversible visible alteration of the security element, which indicates the attempted attack.

Preferably, the irreversible colour change occurs at least 5 kelvins below the upper temperature limit of the effective adhesive range and/or at least 5 kelvins above the lower temperature limit of the effective adhesive range.

In one preferred embodiment, the security element according to the invention has a colour change layer that makes the optical code illegible in the event of a specific temperature limit being exceeded and/or undershot. It is conceivable, for example, for the colour change layer, in the event of the temperature limit being exceeded and/or undershot, to experience a discolouration corresponding to the hue of the optical code. If the colour change layer is provided below or above the optical code, then the discolouration has the effect that the optical code can no longer be discriminated from its surroundings and it can no longer be detected by machine.

It is likewise conceivable for the optical code itself to perform a colour change that has the effect that it no longer stands out visually from its surroundings.

The preferred combination of the irreversible colour change in the event of a temperature limit being exceeded and/or undershot with the functionality of the optical code has the advantage that an attempted attack can be detected by machine during the process of reading out the optical code, without further means being required for the detection of an attempted attack.

In one preferred embodiment, the security element according to the invention has stamped portions which, in the event of an attempt to detach the security element from an object, lead to a division of the security element. Therefore, a detachment of the security element as a whole from an object is made more difficult/prevented by the stamped portions. Forces which act on the security element during a detachment attempt are channelled in a targeted manner by the stamped portions and lead to a division of the security element. The division of the security element is preferably irreversible, which can be achieved e.g. by virtue of the stamped portions not leading through all the layers of the security element, such that in the event of a division, a layer in which no stamped portion is present experiences an irreversible, recognizable separation (destruction) as a result of the division.

The security element according to the invention can be embodied in round, elliptical, oval or n-gonal fashion. However, any other shape desired is also conceivable. The size of the security element according to the invention is between 100 mm² and 10 000 mm².

The security element according to the invention can be combined with further security features known from the prior art, such as e.g. watermarks, special inks, guilloche patterns, microscripts and holograms.

The security element according to the invention permits the use of the IT infrastructure already available for optical codes.

The security element according to the invention is simple and intuitive to use and cost-effective and affords a high protection against forgery.

The present invention furthermore relates to the use of the security element according to the invention for the identification and/or authentication of objects and also for protection against forgery.

For this purpose, the security element according to the invention is connected to an object by means of the adhesive layer. Since the security element according to the invention is embodied as a self-adhesive label, it can be connected to a multiplicity of different objects. Thus, even those objects which would otherwise not be suitable for a method in accordance with WO2005088533(A1) on account of their surface constitution are made accessible to identification/authentication according to a method in accordance with WO2005088533(A1) by the security element according to the invention.

Just the presence of the security element according to the invention on an object indicates the authenticity of the corresponding object and thus serves to afford protection against forgery. From the presence of the security element on the object a person can recognize that the object is very probably an authentic object since the security element cannot be removed from an object and transferred to a different object.

By virtue of a special shape, colour, printing and/or the presence of other visually detectable features, it is possible for a person to perform an examination as to obvious defects with regard to the authenticity of the object without any aids. Furthermore, a person can recognize, without any aids, whether the security element according to the invention has been the subject of an attempted attack: a colour alteration or discernable tearing is possibly present.

Furthermore, the security element according to the invention of an object serves for the identification and authentication of objects.

In one preferred embodiment, the security element according to the invention is detected before being attached to an object. Detection is understood to mean that the characteristic scattering signal from the scattering region of the security element according to the invention is determined and stored in the form of a file that can be processed electronically and by machine, in which case, before, during or after storage, a linkage is effected between the file containing the characteristic scattering signal and the optical code or an identification number printed on the security element by means of an optical code. The security element is registered in this way. It carries an optical code linked to a file containing the characteristic scattering signal. This file is referred to here as a reference data record. The reference data record can contain the entire characteristic scattering signal in digitized form; however, it can also contain just a part, e.g. a characteristic pattern within the signal, a so-called fingerprint. After the security element according to the invention has been detected/registered, it is attached to an object. Since it cannot be removed from the object in a non-destructive manner, it imparts to the object an individual number for identification (optical code) and a unique characteristic feature for authentication (characteristic scattering signal). The use of the security element according to the invention for identification and authentication and also for forgery protection of an object comprises at least the following steps:
(I) determining the characteristic scattering signal of the security element,
(II) linking the characteristic scattering signal to the optical code of the security element,
(III) storing the characteristic scattering signal in the form of a machine-processable file,
(IV) attaching the security element to an object.

Preferably, steps (I) to (IV) are carried out in the stated order, yet the order of steps (II) and (III) can also be exchanged.

The characteristic scattering signal of the security element according to the invention is determined in step (I). The determination is effected by irradiating the scattering region with electromagnetic radiation having at least one wavelength within the range of 300 nm to 1000 nm and detecting the radiation reflected back from the scattering region at different angles. The characteristic scattering signal is preferably determined by means of a method in according with WO2005088533(A1).

According to the invention, the security element is detected before being attached to an object. This has a speed and cost advantage, inter alia. The security elements can be rapidly detected directly after they have been produced. Detected security elements can be generated and stored in stock and be attached to an object as required.

The present invention likewise relates to the method for the identification and authentication of objects on the basis of the security element according to the invention.

The method according to the invention comprises at least the following steps:
(A) reading out an optical code on the security element and determining a reference data record,
(B) determining the characteristic scattering signal of the security element,
(C) comparing the characteristic scattering signal with the reference data record,
(D) outputting a notification with regard to the authenticity of the object in a manner dependent on the result of the comparison in step (C).

The identification and authentication of an object is preferably effected by machine.

Step (A) serves for identifying the object on the basis of the optical code. The reading-out of the optical code in step (A) can be effected by means of a corresponding commercially available scanner for the optical code used. The result is usually an identification number for the object. With regard to details concerning optical codes, reference should be made to the extensive literature concerning the decoding of optical codes (e.g. C. Demant, B. Streicher-Abel, P. Waszkewitz, Industrielle Bildverarbeitung, [Industrial image processing] Springer-Verlag, 1998, pp. 133 ff, J. Rosenbaum, Barcode, Verlag Technik Berlin, 2000, pp. 84 ff). Once the object has been identified, a reference data record can be unambiguously determined The reference data record comprises the characteristic scattering signal of the security element connected to the object, which was determined at an earlier point in time and stored in the form of machine-processable data preferably in a database. The determination can be effected for example by the identification number referring to a corresponding entry in a database at which the reference data record is stored.

The characteristic scattering signal of the security element according to the invention is determined in step (B). The determination is effected by irradiating the scattering region with electromagnetic radiation having at least one wavelength within the range of 300 nm to 1000 nm and detecting the radiation reflected back from the scattering region at different angles. The characteristic scattering signal is preferably determined by means of a method in accordance with WO2005088533(A1).

The order of step (A) and step (B) can be interchanged.

In step (C), the scattering signal determined is compared with the reference data record from step (a) (authentication). By means of the identification of the object on the basis of the optical code on the security element, the corresponding reference data record can be determined very rapidly. The authentication can therefore be effected in a fast 1:1 match of the currently detected scattering data with the reference data record.

In general, the characteristic scattering signal will not correspond 100% to the reference data record. This is caused for example by the fact that the security element according to the invention is subject to an ageing process and the characteristic scattering signal changes on account of environmental influences. Furthermore, when determining the scattering signal it is not always possible to irradiate exactly the same region, such that a slightly varying scattering signal is determined possibly during each authentication process. In general, therefore, a threshold value S is defined. If the degree of correspondence between the characteristic scattering signal and the reference data record is S or more, then correspondence is deemed to exist, and if the degree of correspondence lies below S, then the data records compared are deemed to be different. The characteristic scattering signal determined is present, just like the reference data record, in machine-processable form, that is to say generally as a numerical table. The data records can be compared on the basis of the complete numerical table or on the basis of characteristic features from the numerical table. For this purpose, it is possible to use known pattern matching methods, for example, in which similarities between the data records are sought (see e.g. Image Analysis and Processing: 8th International Conference, ICIAP '95, San Remo, Italy, Sep. 13-15, 1995. Proceedings (Lecture Notes in Computer Science), WO 2005088533(A1), WO2006016114(A1), C. Demant, B. Streicher-Abel, P. Waszkewitz, Industrielle Bildverarbeitung, Springer-Verlag, 1998, pp. 133 ff, J. Rosenbaum, Barcode, Verlag Technik Berlin, 2000, pp. 84 ff, U.S. Pat. No. 7,333,641 B2, DE10260642 A1, DE10260638 A1, EP1435586B1).

Step (D) involves outputting a notification with regard to the authenticity of the object in a manner dependent on the result of the comparison in step (C).

In step (D), it is possible e.g. to effect a notification of whether the object is an authentic object or a forgery. It is possible, for example, to use a light signal for this purpose: if the data records compared in step (C) are deemed to be corresponding, evidently no forgery is involved and e.g. a little green light illuminates; if the data records compared in step (C) are deemed not to be corresponding, evidently a forgery is involved and e.g. a little red light illuminates. As an alternative, an acoustic signal or some other notification that can be picked up by the human senses is also conceivable. Furthermore, it is possible to output the degree of correspondence by means of a printer, monitor or the like.

The security element according to the invention is explained in more detail below on the basis of figures and examples, but without restricting it thereto.

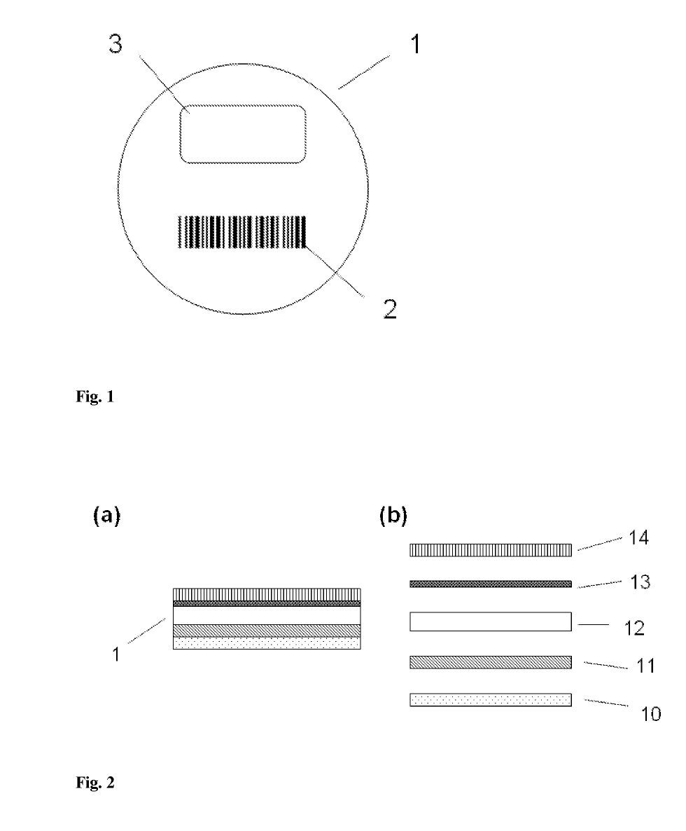

FIG. 1 schematically shows a preferred embodiment of the security element (1) according to the invention comprising a code region (2) and a scattering region (3). The code region (2) comprises an optical code in the form of a bar code printed in a dark hue on a light background. The scattering region (3) is indicated by a frame composed of a solid line. Scattering region (3) and code region (2) are spatially separated from one another. The security element according to the invention in FIG. 1 is embodied in round fashion. The diameter is between 40 and 60 mm in the present example. In addition to the elements illustrated (scattering region, code region, framing), further elements are conceivable, in particular printing with text, images and characters.

FIG. 2 schematically shows the layer construction of a preferred embodiment of the security element according to the invention (a) in cross section, (b) in cross section in an exploded illustration. The layer sequence starting with the bottommost layer is: an adhesive protection layer (10), an adhesive layer (11), a layer comprising a fibrous material (12), a printing layer (13) and a protective layer (14). In the present case, the fibrous material layer (12) fulfils not only the function of providing a desired breaking location in the event of a detachment attempt (separation layer) but also the function of providing randomly distributed and/or oriented scattering centres and the function of receiving the printing ink (printing layer).

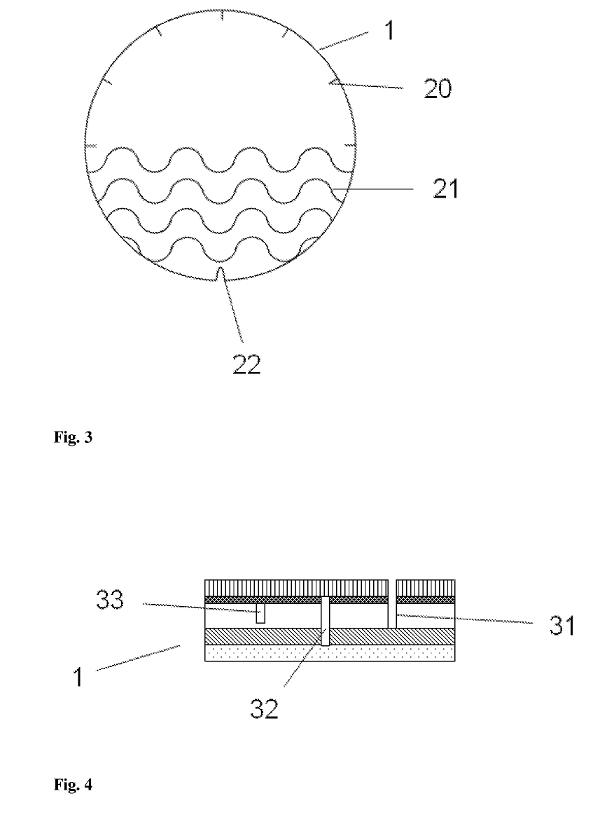

FIG. 3 schematically shows the introduction of stamped portions in a security element (1) according to the invention. There are three types of stamped portions in this embodiment: radial security stamped portions (20) in the edge region of the security element, undulatory security stamped portions (21) running over the security element, and an outer contour stamped portion (22) in the edge region of the security element.

FIG. 4 schematically shows, on the basis of three examples, which layers of a security element according to the invention can be affected by a stamped portion. Further possibilities of stamped portions are conceivable. The layer sequence from FIG. 2 serves for example as the layer sequence. The stamped portion (31) runs through the protective layer, the printing layer and the fibrous material layer. It is conceivable for the stamped portion also to be led through the adhesive layer. A stamped portion in the manner of the stamped portion (31) has the effect that the security element cannot be detached as a whole from an object. A detachment attempt would lead to the division of the security element along the stamping lines. The stamped portion (31) shown has the disadvantage that it runs through the protective layer. As a result, e.g. moisture could penetrate into the layers lying further below and cause damage. The stamped portion (32) runs through the printing layer, the fibrous material layer and the adhesive layer. Here the protective layer is not affected and can therefore fully fulfil its function. Furthermore, in the event of a detachment attempt, the protective layer would tear (irreversible damage), which would be discernible and indicate a detachment attempt. The stamped portion (33) runs partially only through the fibrous material layer. A detachment attempt would be discernible from the irreversible damage in the fibrous material layer and protective layer.

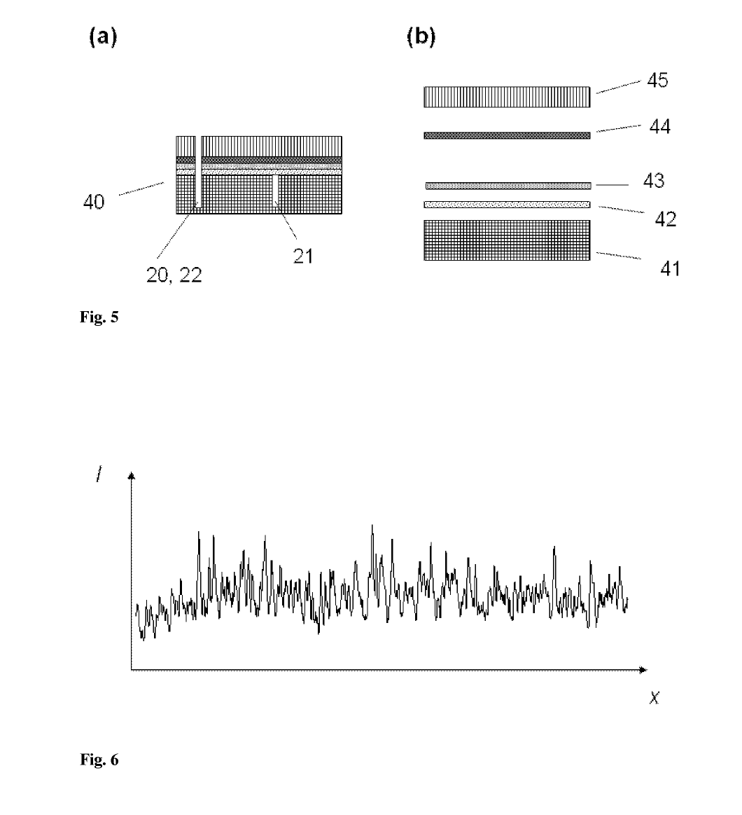

FIG. 5 schematically shows the layer construction of the preferred embodiment of a security element according to the invention from example 1 (for details, see example 1).

FIG. 6 shows the characteristic scattering signal of the preferred embodiment of a security element according to the invention from example 1, measured according to the method described in example 2.

### EXAMPLE 1

### Production and Construction of a Security Element According to the Invention

The construction of a preferred embodiment of the security element according to the invention is illustrated schematically in FIG. 5 (b) in the form of an exploded drawing.

The lower region (41) is formed by the special paper 7110 from 3M (3M 7110 litho paper, white). This special paper is a composite material which already comprises the layer sequence adhesive protection layer, adhesive layer and fibrous material layer. The adhesive layer is a strongly adhering acrylate adhesive whose adhesive force with respect to the substrate (e.g. polyethylene or polypropylene), according to the manufacturer's information, is higher than the strength of the fibrous material layer. The fibrous material layer thus acts as a separation layer that tears in the event of a detachment attempt.

The special paper 7110 is temperature-resistant within the range from −40° C. to 175° C. The matt surface enables printing and thus provides the surface for printing with an optical code (and further printing images, if appropriate). At the same time, the special paper's fibre structure that is unique for each region of the special paper provides for providing randomly oriented and/or distributed scattering centres, such that irradiating the special paper with electromagnetic radiation having at least one wavelength within the range of 300 nm to 1000 nm produces a characteristic scattering signal that makes it possible to authenticate the security element (or the object connected to the security element).

The primer (42) serves for better adhesion of printing ink. The product Indigo Topaz 10 Solution MPS-2056-42 from Hewlett Packard was used here as primer. The primer was applied to the special paper over the whole area by means of known printing techniques (e.g. digital printing). A colour change layer (43) and a printing layer (44) are applied to the primer (42) by means of known printing techniques (e.g. digital printing). The colour change layer (43) comprises a temperature-sensitive change ink that brings about an irreversible change in colour from transparent to black in the event of a temperature of approximately 120° C. being exceeded. The change ink used is commercially available under the name ThermaFlag W/B from the manufacturer Flexo&Gravure Ink. The change ink is preferably printed on only in the code region (in contrast to the illustration in FIG. 5). The optical code is printed onto the change ink by means of known printing techniques (e.g. .digital printing). The termination of the composite is formed by a protective layer (45). A laminate PET Overlam RP35 from UPM Raflatac was applied here as a protective film by means of known laminating methods.

FIG. 5 (a) shows the course of the stamped portions in the security element (40). Three types of stamped portions are present in accordance with FIG. 3: radial security stamped portions (20), undulatory security stamped portions (21) and an outer contour stamped portion (22). The radial security stamped portions (22) and the outer contour stamped portion (22) run through all the layers, as shown schematically in FIG. 5 (a), just the adhesive protection layer (lower part of region (41)) being excluded from the stamped portion. The undulatory security stamped portions (21) run only through the special paper, here as well the adhesive protection layer being excluded from the stamped portion.

### EXAMPLE 2

### Measurement of the Characteristic Scattering Signal of a Security Element According to the Invention

The characteristic scattering signal of the security element according to the invention from example 1 was measured by means of the method described in WO2005088533(A1). The security element according to the invention had the form, the dimensions and the spatial distribution of code region and scattering region in accordance with FIG. 1 and stamped portions in accordance with FIG. 3, in which case the scattering region was not affected by stamped portions.

The scattering signal was measured using a device in accordance with FIG. 1 from WO2005088533(A1), with a Flexpoint® laser of the FP-65/5 type (wavelength 650 nm, maximum power 5 mW) and Si NPN phototransistors of the FT-30 type from STM as detectors.

The beam profile of the laser on the security element was linear with a length of 2 mm and a width of 20 μm. The rigid arrangement of laser and detectors was guided at constant speed (approximately 2 cm/second) transversely with respect to the long side of the beam profile over a region of 1.5 cm of the scattering region.

FIG. 6 shows the intensity I of the scattering radiation detected at a detector (detector 16b from FIG. 1 of WO2005088533(A1)) as a function of the distance x travelled in arbitrary units. The scattering signal is unique for each individual security element according to the invention and can therefore be used for authentication.

### REFERENCE SYMBOLS

1 Label-type security element

2 Code region, comprising an optical code in the form of a bar code

3 Scattering region, visually marked by a framing with a solid line

10 Adhesive protection layer

11 Adhesive layer

12 Fibrous-material-containing layer

13 Printing layer

14 Protective layer

20 Radial security stamped portion

21 Undulatory security stamped portion

22 Outer contour stamped portion

31 Stamped portion through protective layer, printing layer and fibrous-material-containing layer

32 Stamped portion through printing layer, fibrous-material-containing layer and adhesive layer

33 Stamped portion partially through the fibrous-material-containing layer

41 Special paper 7110 from 3M

42 Primer Indigo Topaz 10 Solution MPS-2056-42 from Hewlett Packard

43 Change ink ThermaFlag W/B from Flexo&Gravure Ink.

44 Printing ink

45 Protective layer PET Overlam RP35 from UPM Raflatac

1. (canceled)

2. The security element according to claim 10, wherein the means for preventing non-destructive detachment of the security element from the object are formed by at least one separation layer, security stamped portions and/or a colour change layer, which brings about an irreversible colour alteration in the event of a temperature limit being exceeded and/or undershot.

3. The security element according to claim 10,
further comprising at least an adhesive layer for connecting the security element can be connected to an object,
a fibrous material layer for providing randomly distributed and/or oriented scattering centres that bring about a characteristic scattering signal upon irradiation with electromagnetic radiation,
a printing layer comprising the optical code, and
a protective layer.

4. The security element according to claim 3, wherein the fibrous material layer acts as the separation layer.

5. The security element according to claim 10, wherein the scattering region and the code region are spatially separated from one another.

6. The security element according to claim 10, wherein the scattering region and the code region at least partly overlap one another.

7. A method for using the security element according to claim 10, for identifying and authenticating an object.

8. The method according to claim 7, wherein the security element is detected by determining the characteristic scattering signal in a first step and is connected to an object in a second, subsequent step.

9. A method for the identification and authentication of an object on the basis of a security element comprising the steps of:
a. reading out an optical code on the security element and determining a reference data record,
b. determining the characteristic scattering signal of the security element,
c. comparing the characteristic scattering signal with the reference data record,
d. outputting a notification with regard to the authenticity of the object in a manner dependent on the result of the comparison in step (c.).

10. A security element in form of a self-adhesive label for attaching the security element to an object, the security element comprising
means for preventing non-destructive detachment of the security element from the object,
a code region and a visually marked scattering region,
the code region comprises an optical code, and the scattering region having randomly distributed and/or oriented scattering centers which, when the scattering region is irradiated with electromagnetic radiation, bring about a unique scattering signal that is characteristic of the security element.
